(19) United States
(12) Patent Application Publication
(10) Pub. No.: US 2013/0168266 A1
(43) Pub. Date: Jul. 4, 2013

(54) METHODS AND DEVICES FOR INDENTIFYING AN ANALYTE

(71) Applicant: ALAN JOSEPH BAUER, JERUSALEM (IL)

(72) Inventor: ALAN JOSEPH BAUER, JERUSALEM (IL)

(21) Appl. No.: 13/342,038

(22) Filed: Jan. 1, 2012

(51) Int. Cl. G01N 27/327; G01N 27/26; G01N 27/30

(52) U.S. Cl. 205/785.5; 204/400; 204/403.02

(57) ABSTRACT

The present invention describes a biosensing device and method. Specifically, binding of target analyte to a sensor strip provides for reduction of metal ions in solution. The reduced metal can perform catalytic reactions leading to the production of easily identifiable products such as gas bubbles or colored molecules.

### FIELD AND BACKGROUND OF THE INVENTION

This invention, in some embodiments, pertains to a diagnostic sensor and method for detecting or quantifying analytes. More particularly the present invention is directed to the detection of analytes by production of easily-observable signals specifically in the presence of analyte in a sample.

Pathogen detection has application across a wide range of fields, from medicine to food safety and homeland security. The requirements for pathogen detection are demanding: fast response, ease of use, high sensitivity, low rate of false answers, and appropriate cost. Meeting such needs has led to the development of hundreds of unique diagnostic systems.

U.S. Pat. No. 6,942,518 to Liamos, et al. teaches a small volume sensor, and methods of making, for determining the concentration of an analyte, such as glucose or lactate, in a biological fluid, such as blood or serum, using techniques such as coulometry, amperometry, and potentiometry. The sensor includes a working electrode and a counter electrode, and can include an insertion monitoring trace to determine correct positioning of the sensor in a connector. In one embodiment, the sensor determines the concentration of the analyte by discharging an amount of charge into the sample, determining the time needed to discharge the charge, and determining the current used to electrolyze a portion of the analyte using the amount of charge and the amount of time.

U.S. Pat. No. 6,922,578 to Eppstein et al. describes an integrated device for poration of biological tissue, harvesting a biological fluid from the tissue, and analysis of the biological fluid. The device comprises a tissue-contacting layer having an electrically or optically heated probe to heat and conduct heat to the tissue to form at least one opening, such as a micropore to collect biological fluid from the opening, and a detecting layer responsive to the biological fluid to provide an indication of a characteristic of the biological fluid, such as the concentration of an analyte in interstitial fluid. In the embodiment in which, the probe comprises a photosensitizing assembly designed for the uniform application of a photosensitizing material, such as, for example, a dye or a pigment, to a tissue, e.g., the stratum corneum. In one embodiment, the photosensitizing assembly comprises photosensitizing material combined with a carrier, such as, for example, an adhesive or an ink, and the resulting combination is applied to a substrate, such as, for example, an inert polymeric substrate to form a photosensitizing assembly. In another embodiment, the photosensitizing assembly comprises photosensitizing material incorporated into a film-forming polymeric material.

U.S. Patent Application Number 20040167383 to Kim, et al teaches an automated system for continual transdermal extraction of analytes present in a biological system is provided. The system can be used for detecting and/or measuring the concentration of the analyte using an electrochemical biosensor detection means. The system optionally uses reverse iontophoresis to carry out the continual transdermal extraction of the analytes.

U.S. Patent Application Number 20050112557 to Liu, et al describes a new, sensitive, rapid, portable, and inexpensive biosensor for detection of biological agents. The inventors develop a mesoporous-chip based biosensor device that is able to detect very low-level pathogens in a relatively short time. This biosensor device is designed in a way that significantly increases the reaction area, and constructed by immobilizing antibodies onto a mesoporous chip surface. The antibody-immobilized mesoporous chip is used as a bioseparator for separation of pathogens or other biological agents when the sample goes through the chip pores. Then an enzyme labeled anti-body solution is injected into the chip pores, and a sandwich structure of immunocomplexes (enzyme labeled antibody-biological agent-antibody immobilized on chip) can be formed within the chip pores. The porous chip will also be a bioreactor for catalysis of the enzyme reaction, resulting in easily detected chemical species. The pathogens or other biological agents can be detected through measuring the absorbance or fluorescence of the enzyme reaction and its products. The dramatic increase of the reaction/surface area in the mesoporous chip significantly increases the sensitivity of the biosensor device and shortens the detection time.

### SUMMARY OF THE INVENTION

It is therefore a primary object of some aspects of the present invention to provide an improved analyte detection system, in which a sensor strip composed of a solid base and binding agents is used in the detection analytes through the generation of gas or color specifically when analyte interacts binding agents associated with the sensor strip.

The invention includes a sensor for the detection of an analyte in a sample, including: a sensor strip, wherein the sensor strip minimally includes a solid base having a conductive electrical property and binding agents on at least one side of the solid base, the binding agents showing some level of specificity of interaction with the analyte; a solution, wherein the solution includes hydrogen peroxide at a concentration of 1% v/v or higher, ions, and a redox couple for the solid base at a concentration of 1 mM or less; and, a delivery element, wherein the delivery element is capable of placing a portion of the sample in the solution onto the sensor strip.

In one aspect of the sensor, there is additionally a chemical entity disposed between the solid base and the binding agents on both sides of the solid base.

In another aspect of the sensor, the delivery element is realized as a microfluidic network.

In another aspect of the sensor, there is additionally a unit for identifying bubbles on the sensor strip.

In another aspect of the sensor, the redox couple is silver chloride.

In another aspect of the sensor, the analyte represents a plurality of unique analytes.

In another aspect of the sensor, the solid base is composed of aluminum metal.

In another aspect of the sensor, there is additionally a container realized as a well in a 96-well plate.

The invention additionally includes a method for detecting a predetermined analyte in a sample, comprising the steps of: providing a solution including hydrogen peroxide at a concentration of 1% v/v, and a redox couple for the solid base of a sensor strip, the concentration of the redox couple being selected so as to not allow for spontaneous redox reaction between the redox couple and the solid base; mixing a portion of the sample with the solution; placing the solution with the portion of the sample on a side of a sensor strip, the sensor strip minimally composed of a solid base having a conductive electrical property and binding agents, the binding agents showing some level of specificity of interaction with the analyte; and, detecting gas bubbles on or in proximity to the sensor strip in responsive to presence of the analyte.

In one aspect of the method, there is additionally a step of step of providing a container in which the sensor strip, sample, and solution may be placed.

In another aspect of the method, the step of detecting is performed with an optical-based detection unit.

In another aspect of the method, the step of detecting is performed visually by a user.

In another aspect of the method, the analyte is a pathogen.

In another aspect of the method, the step of detecting includes identifying bubbles above the sensor strip.

In another aspect of the method, the gas bubbles are detected by means of their perturbation of light transmission through the container.

In another aspect of the method, the gas bubbles are detected by their appearance in an optical image of sample taken by a gas bubble detector.

In another aspect of the method, the binding agents represent a plurality of unique binding agents patterned on the solid base for the detection of a plurality of unique pathogens.

In another aspect of the method, the redox couple has a standard reduction potential that is more positive than the standard reduction potential of the solid base.

The invention includes a biosensor for detection or quantification of an analyte in a sample, comprising: a sensor strip composed of a aluminum foil and antibodies displaying some level of specificity of interaction with the analyte, antibodies disposed on at least one side of the solid aluminum foil; a disposable container partially filled with a solution including silver nitrate in a solution of potassium chloride; a first material that may be catalytically modified by silver metal into a first product; and, a detection unit for detecting the first product in proximity to the sensor strip in the container.

In one aspect of the biosensor, the analyte is a pathogenic bacteria or virus.

### BRIEF DESCRIPTION OF THE DRAWINGS

For a better understanding of these and other objectives of the present invention, reference is made to the following detailed description of the invention, by way of example, which is to be read in conjunction with the following drawings, wherein:

FIG. 1 shows a Standard Reduction Potentials chart;

FIG. 2 shows a schematic view of an embodiment of the present invention;

FIG. 3 shows a schematic view of an alternative embodiment of the present invention;

FIG. 4 shows a schematic view of a second alternative embodiment of the present invention;

FIG. 5 shows a schematic view of a third alternative embodiment of the present invention;

FIG. 6 shows a patterned sensor strip for detecting and discriminating pathogen presence in a sample;

FIG. 7 shows a flowchart for a method associated with the instant invention;

FIG. 8 shows a flowchart for an additional method associated with the present invention;

FIG. 9 shows a schematic view of results from diagnostic tests run using an embodiment of the instant sensor; and,

FIG. 10 shows a schematic view of an alternative embodiment of the present invention.

### DESCRIPTION OF THE PREFERRED EMBODIMENT

In the following description, numerous specific details are set forth in order to provide a thorough understanding of the present invention. It will be apparent, however, to one skilled in the art that the present invention may be practiced without these specific details. In other instances well-known circuits and control logic have not been shown in detail in order not to unnecessarily obscure the present invention.

### DEFINITIONS

Certain terms are now defined in order to facilitate better understanding of the present invention. All other terms may generally have their known meaning as applied to respective arts, unless otherwise stated.

An “analyte” or “target” or “target analyte” may be a material that is the subject of detection or quantification.

A “solid base” may be a solid element on which or in proximity to binding agents can be immobilized. The term “solid base” may refer to any solid or other material on which binding agents are physically immobilized. A solid base for the present invention is generally electrically conductive or semiconductive in nature, though in some embodiments it may be electrically insulating. “Electrical property” as it refers to a solid base may generally refer to electrical conduction. A conductive electrical property generally but not exclusively refers to a conductive electrical capability in a solid base. A solid base may be physically associated with a container in which biosensing is to be performed.

“Macromolecules”, “macromolecular binding agents”, “binding agents” or “macromolecular entities” generally are any natural, mutated, synthetic, or semi-synthetic molecules that are capable of interacting with a predetermined analyte or group of analytes at some level of specificity.

A “binding agent layer” may be a layer composed of one or a plurality of binding agents. The binding agent layer may be composed of more than one type of binding agent. A binding agent layer may additionally include molecules other than binding agents. Cross-linking agents may be applied to bind separate components of a binding agent layer together.

A “chemical entity” may be a chemical layer that is disposed proximate a solid base either one or both sides of the solid base. The chemical entity generally rests between the solid base and the binding agent layer. The chemical entity serves to immobilize binding agents proximate solid base. Chemical entities may be differentially deposited on opposite sides of a solid base surface by any means or multiple layers on a given side of the solid base may be considered a single chemical entity.

A “packaging layer” is generally as a chemical layer disposed above the binding agent layer. The packaging layer may aid in long term stability of the macromolecules, and in the presence of a sample that may contain analyte of interest, the packaging layer may dissolve to allow for rapid interaction of analyte and binding agents.

A “sensor strip” is generally defined as a minimum of a single solid base and any physically associated binding agents. The solid base and binding agents, chemical entities, packaging layers or other elements physically associated with the solid base are generally included in the term “sensor strip” as used in the instant invention.

A “peroxide” may refer to any material of structure R—O—O—R′. In hydrogen peroxide, R═R′=hydrogen. The expression “peroxide” refers to hydrogen peroxide and other members of this class of chemicals.

“Gas”, “gas bubble”, “bubbles” may generally have their normal meaning as applied to the physical and chemical arts. Gas bubbles are generally detected on a sensor strip though they may be detected “in proximity” to a sensor strip, proximity referring to any position within a container in which sensor strip is present.

“Oxygen-sensitive reagent” is any chemical or material that changes color or other noticeable property as a result of the interaction of said chemical or material with oxygen.

“Oxidation”, “reduction”, “reduction potential”, and “redox” may generally have their normal meanings as described in the electrochemical arts. “Redox compound” may be a material capable of performing an oxidation or reduction reaction, while a “redox couple” may be a material that can perform a redox reaction generally with a solid base associated with a sensor strip. A non-limiting example of a redox couple for aluminum solid base is silver ion (Ag⁺), as aluminum can reduce silver ions to silver metal, the silver metal then capable of performing catalytic chemistry. Silver ions or other appropriate redox couples may be reduced by a solid base specifically when analyte is present; otherwise it remains in its oxidized form.

Non-limiting examples of redox couples for solid base when solid base is aluminum include materials that have a standard reduction potential that is more positive than −1.6 eV, such as silver, silver chloride, cupric ion, iron in plus 2 or plus 3 state, gold cation, lead cation, tin cation, zinc cation, mercury cation, nickel cation, and any compound including any of the above ions.

One will appreciate that the overall potential of an oxidation-reduction system is not merely the values recorded in a reduction potential table. The Nernst Equation describes the actual potential in a system, taking into account the concentrations of the electrochemically active species. Thus, in the present invention, in some embodiments, a redox couple for a solid base is present at such a concentration that either no redox reaction spontaneously occurs or any redox that may occur is not appreciable. Analyte leads to concentration of redox couple in the vicinity of solid base.

A “delivery element” may be a device or component that is capable of delivering a sample, generally liquid in nature, to the surface of a sensor strip. Typical delivery elements include but are not limited to pipettes, microfluidic elements, and droppers.

“Patterning” may refer to placing binding agents in predetermined locations or patterns on a sensor strip.

Without being bound by any particular theory, the following discussion is offered to facilitate understanding of the invention. The sensor disclosed herein is based on analyte-responsive redox chemistry. The sensor utilizes a novel method of detecting an analyte wherein macromolecular binding agents are first immobilized as a binding agent layer proximate a electrically conductive solid base. Solid base may be any solid material with a conductive or semiconductive property. Sample with analyte is generally present in a solution that includes a redox couple. If analyte binds to a binding agent, the redox couple is reduced to a metal which can perform catalytic reactions that the free redox couple cannot perform. In the process, a product is produced, the product being easily identified, or alternatively the energy released in product formation may be measured as heat. Where analyte is not present, redox couple remains oxidized in solution and no redox reaction occurs, and no catalytic product is detected.

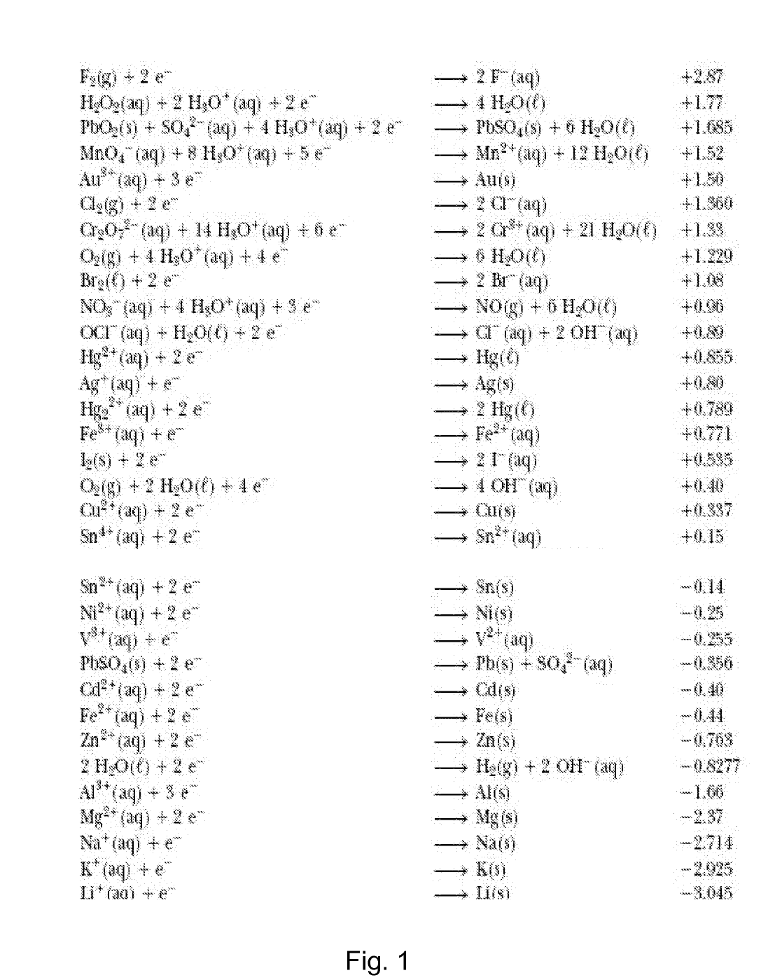

FIG. 1 shows a traditional Reduction Potential Table. Ion/metal systems that have a higher standard reduction potential that the metal or other material used in some embodiments as solid base allow for reduction of ion to metal by solid base, specifically when target is present in sample. For example, aluminum, with a standard reduction potential of 01.66 eV can easily reduce Ag+ ions to silver metal, as the latter has a standard reduction potential of +0.80.

In some embodiments of the instant invention, an electrically-conductive solid base is presented with a solution that includes redox couple that may associate with analyte. Binding of analyte allows for reduction of the redox couple by solid base, the reduced redox couple interacting with a material in solution to catalytically produce an easily-identifiable product.

In the various embodiments disclosed herein, like elements have like reference numerals differing by multiples of 100.

### First Embodiment

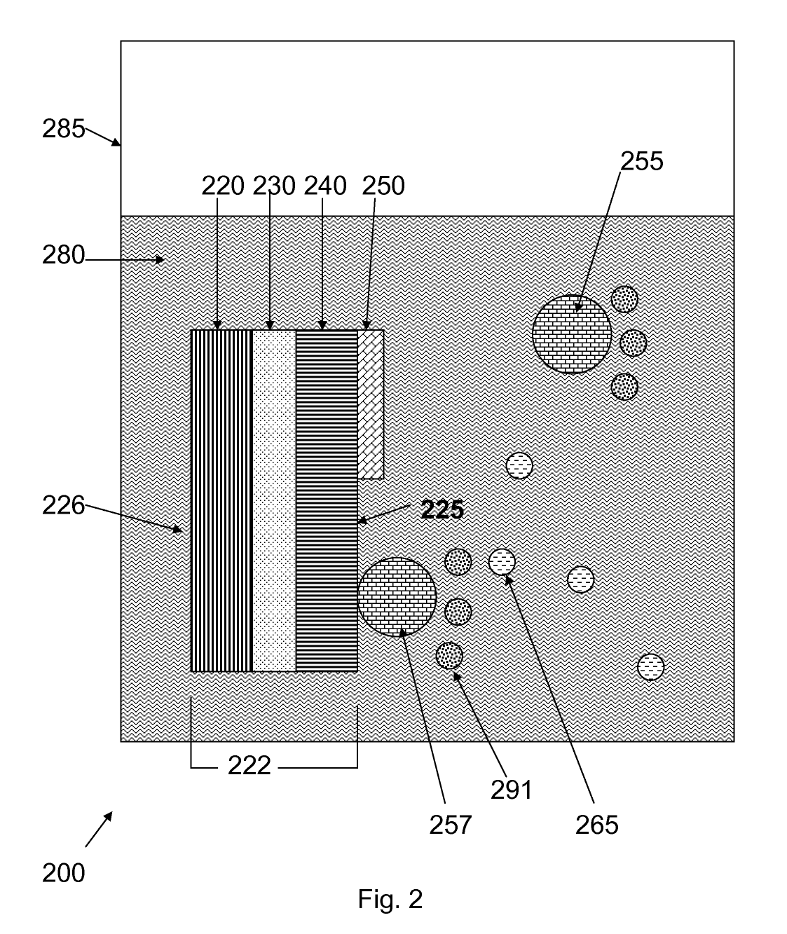

Reference is now made to FIG. 2, which is a schematic of a sensor detection system (200) that is constructed and operative in accordance with a preferred embodiment of the invention. Container (285) holds solution (280) that includes sample containing unbound analyte (255) and buffered hydrogen peroxide, H₂O₂ (265) at a concentration of greater than 0.001% (volume:volume) but not in excess of 10% (volume:volume). A sensor strip (222) composed of solid solid base (220), chemical entity (230), binding agent layer (240) and packaging layer (250, shown in part prior to its dissolution) is present in the container (285) and in contact with solution (280). The packaging layer (250) dissolves in solution (280) to allow for binding of analyte (257, bound analyte). Bound analyte (257) is found on a first side (225) of sensor strip (222) as sensor strip (222) is exposed to solution (280). The result of this arrangement is that a redox couple (291) associated with bound analyte (257) may be reduced by solid base (220), the reduced—but not the oxidized—redox couple (291) catalytically converting hydrogen peroxide (265) to oxygen gas. Oxygen gas as a product of hydrogen peroxide (265) breakdown may be detected by several means, including but not limited to visual observation of bubbles on or near sensor strip (222), photographic identification of bubbles, or scattering of light by gas bubbles. Sample lacking analyte (255) will not drive the redox reaction between solid base (220) and its redox couple (291) which remains diffuse in solution (280) and there will be no signal as oxidized redox couple (291) cannot break down hydrogen peroxide (265).

To note, both sides (225 & 226) of sensor strip (222) may be coated identically with chemical entity (230), binding agent layer (240) and packaging layer (250). In FIG. 2, these layers are shown only one side (225) for convenience of viewing. In some embodiments, only one side is exposed to solution (280). In some embodiments, the sensor strip (222) may be a portion of the container (285).

The packaging layer (250), shown in part in FIG. 2, is generally a layer of water-soluble chemicals deposited above the immobilized macromolecules of the binding agent layer (240). The packaging layer (250) may be deposited by soaking or spraying methods. The packaging layer (250) serves to stabilize the binding agent layer (240) during prolonged dry storage. In the absence of a packaging layer, oil and dirt may build up on the hydrophilic binding agent layer (240) and may interfere with the rapid action of the sensor system. A commercial solution, StabilGuard (Surmodics, Inc., 9924 West 74^{th} Street, Eden Prairie, Minn., 55344, USA) is typically used for the packaging layer (250) so as to guarantee packaging layer dissolution in aqueous samples, and thus facilitate direct interaction between macromolecular binding agents of binding agent layer (240) and analytes (257). Other chemicals may be chosen for use in the packaging layer. Water-soluble polymers, sugars, salts, organic, and inorganic compounds are all appropriate for use in preparation of the packaging layer (250).

As shown in FIG. 2, free analyte (255) is disposed proximate the packaging layer (250) prior to the latter's dissolution. When the packaging layer (250) dissolves, the macromolecules incorporated in the binding agent layer (240) are free to immediately interact with analyte (257), as shown in FIG. 2. After dissolution of the packaging layer (250), analyte (257) is shown interacting with the binding agent layer (240). The analyte (255, 257) can be a member of any of the following categories, listed herein without limitation: cells, organic compounds, antibodies, antigens, virus particles, pathogenic bacteria, toxins, metals, metal complexes, ions, spores, yeasts, molds, cellular metabolites, enzyme inhibitors, receptor ligands, nerve agents, peptides, proteins, fatty acids, steroids, hormones, narcotic agents, synthetic molecules, medications, enzymes, nucleic acid single-stranded or double-stranded polymers. The analyte (255) can be present in a solid, liquid, gas or aerosol. The analyte (255) could even be a group of different analytes, that is, a collection of distinct molecules, macromolecules, ions, organic compounds, viruses, toxins, spores, cells or the like that are the subject of detection or quantification. Some of the analyte (257) physically interacts with the sensor strip (222) after dissolution of the packaging layer (250) and causes an increase in catalytic degradation of hydrogen peroxide to water and oxygen gas. There is no requirement for application of a voltage or other electrical signal to the sensor strip (222) prior to or during biosensing and in most embodiments there is no requirement for an external electrode whatsoever. In some embodiments, a single oxygen electrode may be employed for measurement of pO₂.

Examples of macromolecular binding agents suitable for use as the binding agent layer (240) include, but are not limited to enzymes that recognize substrates and inhibitors, antibodies that bind antigens, antigens that recognize target antibodies, receptors that bind ligands, ligands that bind receptors, nucleic acid single-strand polymers that can bind to form DNA-DNA, RNA-RNA, or DNA-RNA double strands, and synthetic molecules that interact with targeted analytes. The present invention can thus make use of non-redox enzymes, peptides, proteins, antibodies, antigens, catalytic antibodies, fatty acids, receptors, receptor ligands, nucleic acid strands, as well as synthetic macromolecules as the binding agents in the binding agent layer (240). Natural, synthetic, semi-synthetic, over-expressed and genetically-altered macromolecules may be employed as binding agents. The binding agent layer (240) may form monolayers, multilayers or mixed layers of several distinct binding agents or binding agents with other chemical components (not shown). A monolayer of mixed binding agents may also be employed (not shown). The binding agents in the binding agent layer (240) may be cross-linked together with glutaraldehyde or other chemical cross-linking agents.

The macromolecule component of the binding agent layer (240) is neither limited in type nor number. Non-redox enzymes, peptides, receptors, receptor ligands, antibodies, catalytic antibodies, antigens, cells, fatty acids, synthetic molecules, and nucleic acids are possible macromolecular binding agents in the present invention. The sensor detection system (200) may be applied to detection of many classes of analyte because it relies on the following properties shared by substantially all applications and embodiments of the sensor detection system according to the present invention:

(1) that the macromolecules chosen as binding agents are generally specific entities designed to bind only with a selected analyte or group of analytes;

(2) that analytes may interact at a level of specificity with the binding agents associated with a sensor strip;

(3) that binding of analyte may bring an analyte-associated redox couple into proximity to solid base component of a sensor strip where the redox couple may be reduced by solid base; and

(4) that a redox reaction between solid base and redox couple may yield metal atoms capable of catalyzing a chemical reaction to yield an easily-identifiable product.

The broad and generally applicable function of the sensor detection system (200) is preserved during formation of the binding agent layer (240) in proximity to the solid base (220) because the binding agent layer (240) formation can be effected by either specific covalent attachment or general physical absorption. A chemical entity (230), such as a self-assembled monolayer, may be used in the physical absorption of the binding agent layer (240) proximate the solid base (220). It is to be emphasized that the catalytic degradation of hydrogen peroxide that is associated with analyte presence does not depend on any specific enzyme chemistries, optical effects, fluorescence, chemiluminescence or applied electrical signals. These features are important advantages of the present invention.

### Second Embodiment

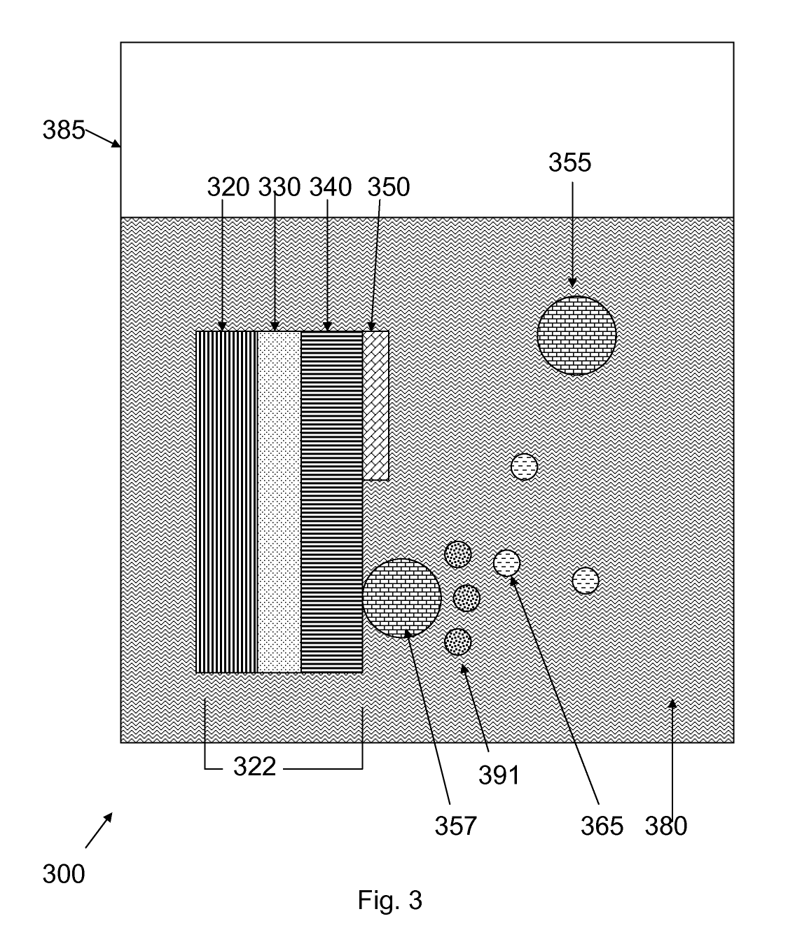

Reference is now made to FIG. 3, which is a schematic of a an alternative embodiment of a sensor detection system (300) that is constructed and operative in accordance with a preferred embodiment of the invention. Container (385) holds solution (380) that contains sample with un-bound analyte (355) and buffered hydrogen peroxide, H₂O₂ (365) at a concentration of greater than 0.0001% (volume:volume) but not in excess of 10% (volume:volume). A sensor strip (322) composed a solid base (320) which is a portion of the container (385), optional chemical entity (330), binding agent layer (340) and packaging layer (350) is present in the container (385) when sample is added. The packaging layer (350) dissolves to allow for binding of analyte (357, bound analyte) by binding agents in binding agent layer (340). Bound analyte (357) is found on a first side (325) of sensor strip (322) as sensor strip (322) is exposed to solution (380). The result of this arrangement is that a silver chloride (391) associated with bound analyte (357) may be reduced by solid base (320), the reduced couple catalytically converting hydrogen peroxide to oxygen gas. Oxygen gas as a product of hydrogen peroxide (365) breakdown may be detected by several means, including but not limited to visual observation of bubbles on or near sensor strip (322), photographic identification of bubbles, or scattering of light by gas bubbles. Sample lacking analyte (355) will not drive the redox reaction between solid base (320) and redox couple silver chloride (391) which remains diffuse in solution (280) and there will be no signal.

### Third Embodiment

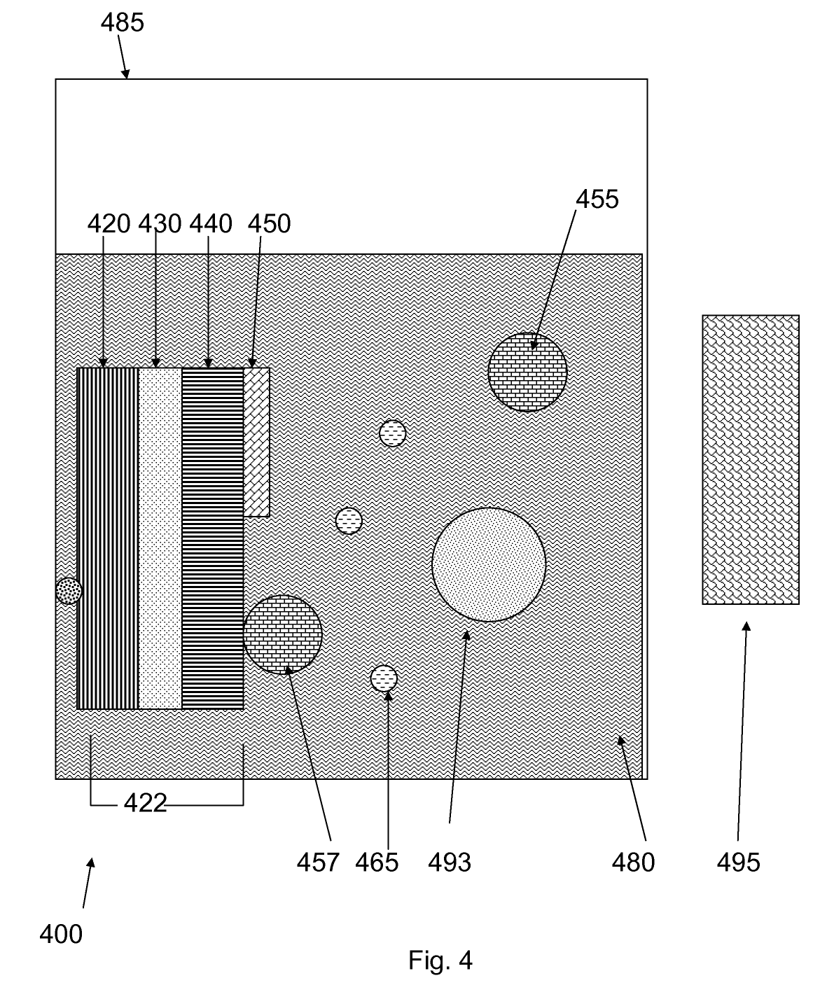

Reference is now made to FIG. 4, which is a schematic of an alternative embodiment of a sensor detection system (400) that is constructed and operative in accordance with a preferred embodiment of the invention. Container (485) holds a solution (480) that contains sample with un-bound analyte (455) and buffered hydrogen peroxide, H₂O₂ (465) at a concentration of greater than 0.001% (volume:volume) but not in excess of 10% (volume:volume). A sensor strip (422) composed of solid solid base (420) with two sides exposed to solution (480), chemical entity (430), binding agent layer (440) and packaging layer (450) is added to the container (485) when solution (480) with sample is present. The packaging layer (450) dissolves to allow for binding of analyte (457, bound analyte). Bound analyte (457) leads to oxygen gas bubble (493) formation in proximity to the sensor strip (422). A bubble detector (495) placed outside of the container (485) detects bubble (493) presence by photographic, optical, or other means. Bubble (493) presence signals analyte (455, 457) presence and binding to binding agently layer (440) of sensor strip (422).

### Fourth Embodiment

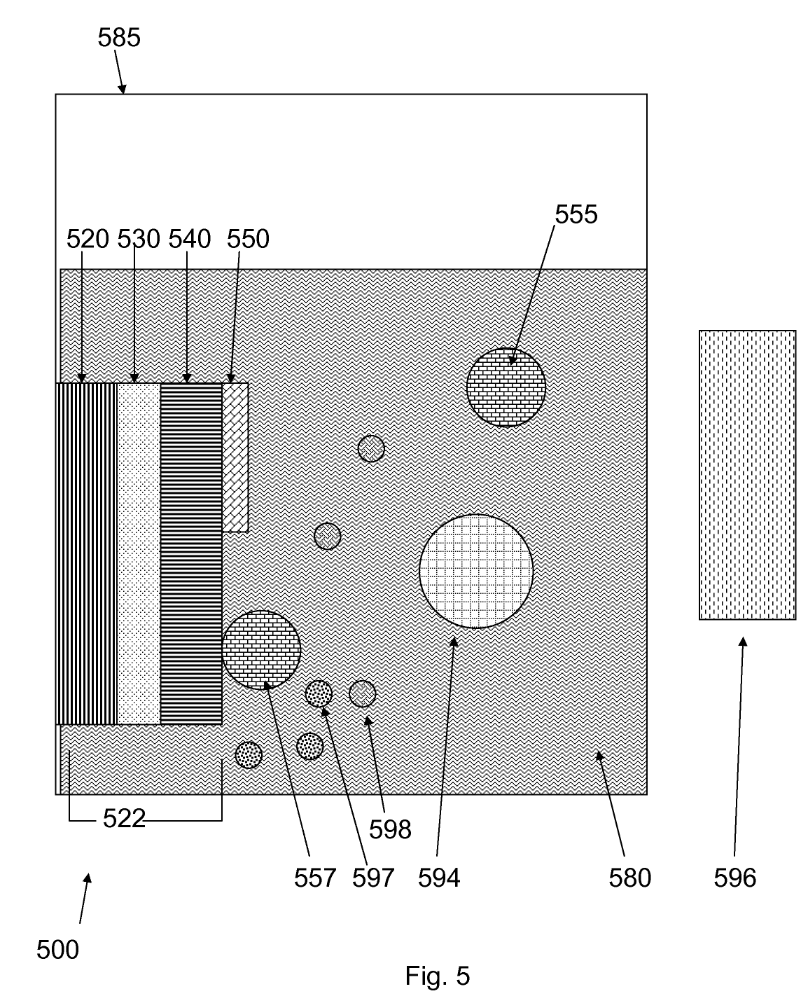

Reference is now made to FIG. 5, which is a schematic of an alternative embodiment of a sensor detection system (500) that is constructed and operative in accordance with a preferred embodiment of the invention. Container (585) holds a solution (580) that contains sample with un-bound analyte (555) and, redox couple (598) at a predetermined concentration. A sensor strip (522) composed of solid base (520), chemical entity (530), binding agent layer (540) and packaging layer (550) is added to the container (585) when solution (580) with sample is present. The packaging layer (550) dissolves to allow for binding of analyte (557, bound analyte). Bound analyte (557) leads to chromophore (594) formation in proximity to the sensor strip (522) through reduction of redox couple (598) by solid base (520). A color detector (596) placed outside of the container (585) detectors chromophore (594) presence by photographic, optical, or other means. Chromophore (594) presence signals analyte (555) presence and binding to binding agent layer (540) of sensor strip (522). The chromophore (594) might even be reduced metal ions, such as silver metal, gold metal, or copper metal.

In the two previous embodiments, creation of a product that may be detected either by sight (bubbles, unique color) or by detectors designed to detect analyte-responsive signals such as gas bubbles or color generation. Gas and colored molecules may be produced by catalysis driven by metal atoms generated specifically in the presence of analyte. As only successful, specific binding of target to a sensor strip leads to redox couple reduction, only samples positive in analyte will show the product associated with reduced ions and catalysis that may follow afterwards.

It is understood that the instant invention can be multiplexed to detect a single analyte or a plurality of analytes. Additionally, sensor strips may be patterned with different binding agents, so that the location of bubbles, chromophores, or other detectable products may be associated, via their specific location on the patterned strip, to the specific analyte present in sample.

### Fifth Embodiment

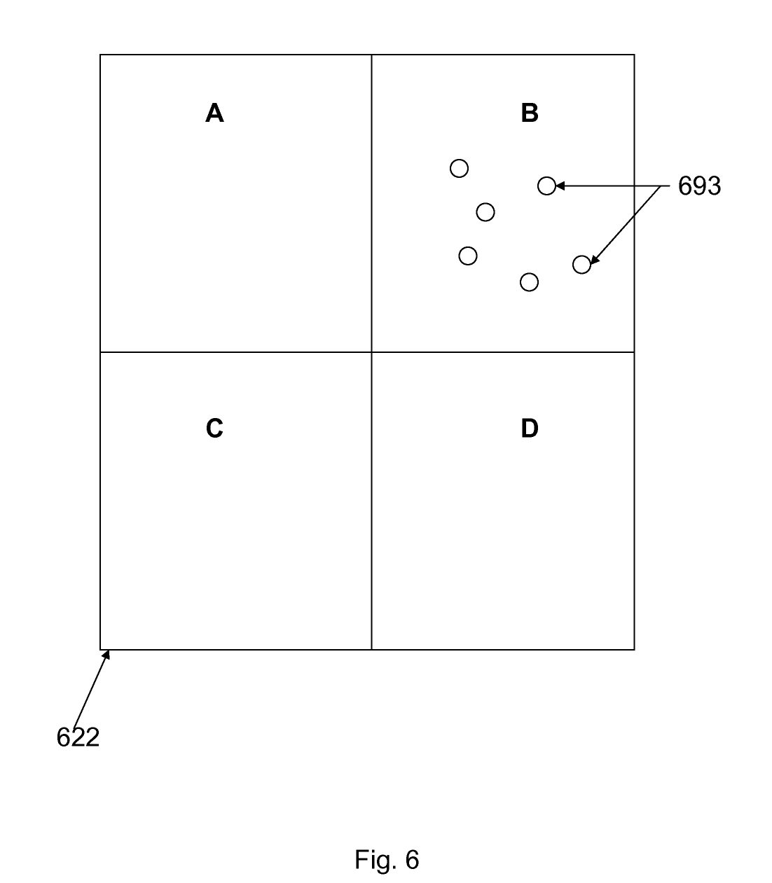

Reference is now made to FIG. 6 which shows a patterned sensor strip (622), having four unique regions with binding agents for different pathogenic targets. Region A has antibodies to Salmonella, while region B has antibodies to E. coli O157:H7; region C has receptors specific for binding Listeria, while region D has DNA that recognizes DNA unique to Pseudomonas. As shown in the figure, bubbles (693) appear only in region B and thus signal to a user than for the sample in question, E. coli O157:H7 is present, but the other three pathogens were not detected. In this embodiment, no container is required: sample with appropriate solution is placed directly onto a side of sensor strip (622).

### Sixth Embodiment

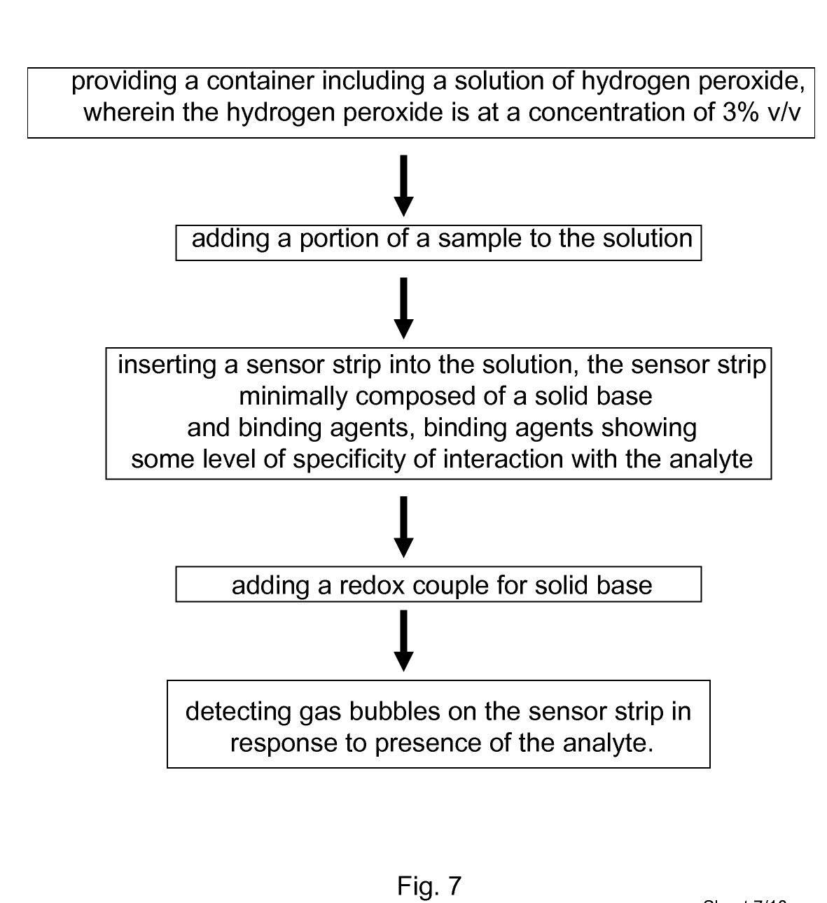

Reference is now made to FIG. 7, which shows an additional method associated with an embodiment of the present invention. The method for detecting an analyte includes the following steps: providing a container including a solution of hydrogen peroxide, wherein the hydrogen peroxide is at a concentration of 3% v/v; adding a portion of the sample to the solution; mixing the portion of the sample and the solution; inserting a sensor strip into the solution, the sensor strip minimally composed of a solid base having an electrical property and binding agents, the binding agents showing some level of specificity of interaction with the analyte; adding a redox couple for solid base; and, detecting gas bubbles on the sensor strip in response to presence of the analyte. To note, the hydrogen peroxide concentration may be more or less than 3%, and the solution may be stabilized or not. The redox couple is generally silver chloride (standard reduction potential of +0.22 eV), though other redox materials may be used. A container, when employed, may generally be disposable and it may also be a plurality of containers, such as 96 (for example) wells typically found in plates used for diagnostic purposes. Hydrogen peroxide may alternatively be added to a sensor strip already present in a container. Sample or a portion thereof may be added, and the final addition is generally the solution including the redox couple, though it may be present in the original solution in other embodiments. Alternatively, no container may be required.

### Seventh Embodiment

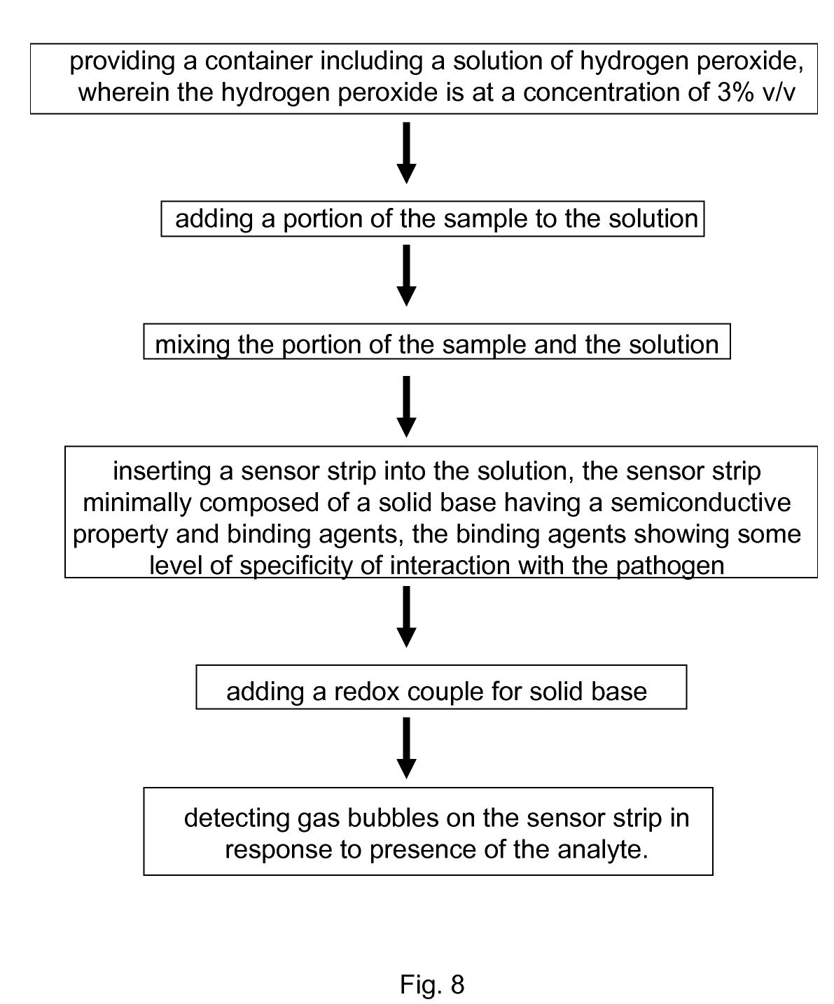

Reference is now made to FIG. 8, which shows an additional method associated with an embodiment of the present invention. The method for detecting a pathogen includes the following steps: providing a container including a solution of hydrogen peroxide, wherein the hydrogen peroxide is at a concentration of 3% v/v; adding a portion of the sample to the solution; mixing the portion of the sample and the solution; inserting a sensor strip into the solution, the sensor strip minimally composed of a solid base having a semiconductive property and binding agents, the binding agents showing some level of specificity of interaction with the pathogen; adding a redox couple for solid base; and, detecting gas bubbles on the sensor strip in response to presence of the analyte. To note, the hydrogen peroxide concentration may be more or less than 3%, and the solution may be stabilized or not. The aqueous ions may be supplied by salt solutions including but limited to sodium chloride, potassium chloride, magnesium chloride as well as the nitrate salts of the same cations. The container may generally be disposable and it may also be a plurality of containers, such as 96 (for example) wells typically found in plates used for diagnostic purposes. Hydrogen peroxide may alternatively be added to a sensor strip already present in container. Sample or a portion thereof may be added, and the final addition is generally the solution including the aqueous ions of lower reduction potential than the metal present in the sensor strip. The target pathogen may be a plurality of pathogens; it may also be a virus, bacterium, yeast, fungus or other form of life.

### Example 1

The analysis in this example was performed using the embodiment of FIG. 2. Testing for E. coli O157:H7 in ground beef was performed. Aluminum foil having a matte surface and a shiny surface (Extra Heavy-Duty Diamond Foil, Reynolds Metals Co., 555 Guthridge Court, Norcross, Ga. 30092) was cut into 25 centimeter by 30 centimeter pieces and soaked in an ethanolic (Carmel Mizrahi, Rishon Letzion, Israel, 95%) solution of docosanoic acid (21, 694-1, Aldrich Chemical Company, Milwaukee, Wi.) for 20 minutes and then rinsed with distilled water. The soakings were performed in disposable aluminum baking pans, with the self-assembled monolayer (SAM) surfactant solution being 200 milliliters. Hydrophobic SAM-coated foil pieces were next transferred to 20 milliliters of aqueous phosphate-buffered solutions (pH 7.2) of monoclonal antibodies specific for E. coli O157:H7 antigen (Product C65310M, Meridian Life Science, 60 Industrial Park Road, Saco, Me. 04072 USA) at an approximate concentration of 10 microgram per milliliter in a total volume of approximately 300 mL of solution. The solution was kept in contact with the SAM-coated aluminum foil for approximately 20 minutes and then the coated aluminum foil was next soaked for 20 minutes in 200 milliliters of ten-fold diluted StabilGuard (SG01-0125, Surmodics, 9924 West 74^{th} Street, Eden Prairie, Minn. 55344). After this final coating, the coated foil was dried at 37 degrees Celsius for approximately one hour, after which it was stored at room temperature. The foils were coated on both sides.

Prior to use, the coated foil was cut into 1 cm×1 cm square coated sensor strip. 16 well plate (NUNC, www.nuncbrand.com) was provided. Each well had a volume maximum of 400 uL. 250 uL of 3% v/v stabilized hydrogen peroxide was placed in a well of the plate. 50 uL of meat sample was added. Meat sample was prepared by suspending 8 grams of Kosher ground beef (Mataam Chafetz Chaim, Jerusalem) in 45 milliliters of mineral water (Neviot, Israel). The red supernatant was separated from the meat debris by gravity, and the supernatant was used for the example herewith described. Negative sample was meat-water supernatant, while positive sample had 10⁻⁴ dilution of overnight growth of E. coli O157:H7 diluted to this concentration in the meat supernatant (two consecutive 100-fold dilutions). After addition of meat sample without or with target pathogen (E. coli O157:H7), a coated sensor square was added to the well and pushed with a pipet tip to the bottom of the well, where it sat. After one minute, 50 uL of 1.3 M KCl (Aldrich Chemicals) with 1 mM silver nitrate (Aldrich Chemicals) was added. Positive sample gave bubbles within a minute, bubbles appearing both on the strip at the base of the well as well as on the walls of the well. The negative meat sample showed no bubble formation. 50 microliters of a ten thousand-fold dilution of target pathogen implies several hundred cells present in testing well; experiments were complete in less than 3 minutes.

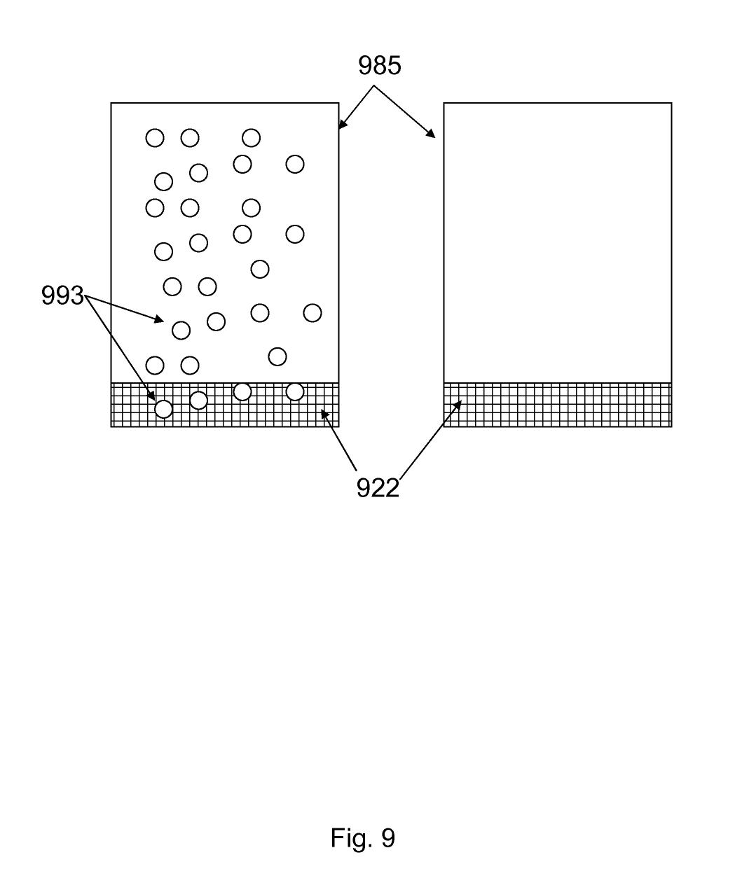

FIG. 9 shows a schematic view of the results of the experiment. Containers (985) included liquid samples described above. Sensor strip (922) was placed at base of well container (985). Positive sample (left) showed bubbles (993) while negative sample (right) showed no bubbles, as shown schematically in the figure. Hydrogen peroxide was the redox compound while silver ion was the redox couple for this example.

### Eighth Embodiment

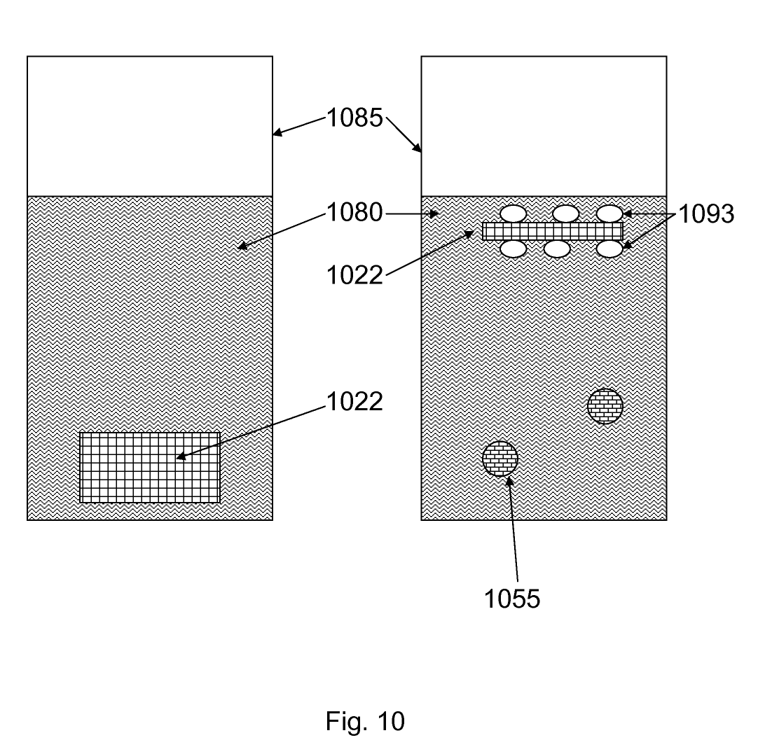

Attention is turned to FIG. 10 which shows an alternative embodiment of the instant invention. Containers (1085) hold solutions (1080) that have sensor strips (1022) are exposed to solution (1080). The container (1085) on the right has analyte (1055), while the container (1085) on the left does not. Gas bubbles (1093) associated with sensor strip (1022) on the experiment to the right, created in response to analyte (1055) presence, have lifted the sensor strip (1022) to the top of the solution (1080). Thus, one mode of detection includes detecting a sensor strip (1022) that is either floating in containers (1085) or has elevated positions in containers (1085) due to modified buoyancy. If there is no analyte (1055) present, gas bubbles are not generated and sensor strip (1022) remains near the bottom of the container (1085) as seen on the left side of the figure.

The implications of the invention described herein are that nearly any material that can be recognized at a level of specificity by a peptide, protein, antibody, enzyme, receptor, nucleic acid single strand, synthetic binding agent, or the like can be detected and quantified safely in food, body fluids, air or other samples quickly, cheaply, and with high sensitivity. Response is very rapid, generally less than 10 minutes. Cost of manufacture is low, and sensitivity has been shown to be very good. It is understood that one could detect bubble presence by either identifying a floating sensor strip, floating due to the presence of bubbles on the strip or alternatively by detecting the sound of bubbles effervescing in solution. The invention herewith described could be used to drive a wide range of redox reactions, with the potential difference between the solid base and the sensor surface being the driver for reactivity.

The present invention has been described with a certain degree of particularity, however those versed in the art will readily appreciate that various modifications and alterations may be carried out without departing from the spirit and scope of the following claims. Therefore, the embodiments and examples described here are in no means intended to limit the scope or spirit of the methodology and associated devices related to the present invention. Sample may be presented to the sensor strip by static or flow means, including but not limited to microfluidic delivery of sample to sensor strip.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. A sensor for the detection of a predetermined analyte in a liquid sample, including:
an optically-clear disposable container adapted to hold a portion of said liquid sample;
a sensor strip composed of aluminum foil coated with binding agents displaying some level of specificity of interaction with said predetermined analyte; and,
an oxygen-sensitive reagent adapted to change color or other noticeable property as a result of interaction of said reagent with oxygen.

22. The sensor according to claim 1, further comprising a chemical entity disposed between said solid base and said binding agents on both sides of said solid base.

23. The sensor according to claim 1, wherein said oxygen-sensitive reagent includes an iron III ion.

24. The sensor according to claim 1, further including a detection unit for detecting a color associated with said oxygen sensitive reagent.

25. The sensor according to claim 3, wherein said iron III ion is associated with a compound.

26. The sensor according to claim 1, wherein said analyte represents a plurality of unique analytes.

27. The sensor according to claim 5, wherein said aluminum foil is realized as Reynolds aluminum foil.

28. The sensor according to claim 1, wherein said container is realized as a well in a 96-well plate.

29. A method for determining the presence of a predetermined analyte in a sample including:
providing an optically-clear disposable container adapted to hold a portion of said sample, wherein said container is adapted to include a sensor strip composed of aluminum foil coated with binding agents displaying some level of specificity of interaction with said predeferminid analyte;
placing a portion of said sample in said disposable container, wherein said portion and said sensor strip are in physical contact;
mixing said portion of said sample in said container;
adding an oxygen-sensitive reagent to said container wherein said oxygen-sensitive reagent is adapted to change color or other noticeable property as a result of interaction of said reagent with oxygen;
detecting the presence or absence of a predetermined color associated with said oxygen-sensitive compound; and,
determining the presence or lack of said analyte as per the absence or presence of said color.

30. The method according to claim 29, wherein said detecting is performed with an optical-based detection unit.

31. A device for the detection of a predetermined analyte in a liquid sample, including:
an optically-clear disposable container adapted to hold a portion of said liquid sample;
a sensor strip composed of aluminum foil coated with binding agents displaying some level of specificity of interaction with said predetermined analyte;
an oxygen-sensitive reagent; and,
an optical-based detection unit.
